(19) United States
(12) Patent Application Publication
(10) Pub. No.: US 2024/0106771 A1
(43) Pub. Date: Mar. 28, 2024

(54) INSTANT INTELLIGENT COMMUNICATION SYSTEM FOR STRANGERS

(71) Applicant: HSIANG-SHIH LIU, Taiwan (TW)

(72) Inventor: HSIANG-SHIH LIU, Taiwan (TW)

(21) Appl. No.: 18/530,356

(22) Filed: Dec. 6, 2023

(30) Foreign Application Priority Data
Jun. 5, 2023 (CN) 202310656764.5

(51) Int. Cl. H04L 51/04; H04L 9/40; H04L 67/141

(52) U.S. Cl. CPC H04L 51/04; H04L 63/08; H04L 67/141

(57) ABSTRACT

An instant intelligent communication system for strangers is disclosed. The system includes a registration module, a business management module and a communication module. The registration module generates a personal unique identification code. The business management module issues or acquires business information. The communication module initiates a communication establishment request according to the personal unique identification code or the business information. The communication establishment module receives the communication establishment request and establish communication. The communications can be initiated and established through the business information issued on the Internet platform server, so that the business docketing is formed, and the business communication capability is greatly facilitated.

### TECHNICAL FIELD

The invention relates to the technical field of intelligent communications, in particular to an instant intelligent communication system for strangers.

### TECHNICAL FIELD

Communications between a buyer and a seller cannot be directly established in the existing e-commerce platform, further business communications cannot be directly made in a communication or video. Meanwhile, products in a shop can only be displayed through videos or pictures with propaganda properties provided by merchants, people cannot access real products, and the transaction quality is greatly reduced.

In addition, the communications in existing communication system can only be made on the premise of a friend relationship established, and can only communicate through a chat frame before establishing the friend relationship, so that a long transition period can be generated, the communication efficiency, productivity, transaction quality are greatly reduced, and is not suitable for frequent business in an e-commerce platform.

Therefore, there are needs to improve the convenience of communication and facilitate frequent business communication.

### SUMMARY

In view of this, the present invention provides a instant intelligent system for the strangers, which provides a convenient communications establishment channel, thereby accelerating the formation and circulation of services, and greatly facilitating the business communication capability to cope with frequent business communications scenarios.

In order to achieve the aims as above, the present invention adopts the technical scheme as follows.

An instant intelligent communication system for strangers including a registration module, a business management module and a communication module is provided.

The registration module is used for generating a personal unique identification code.

The business management module is used for issuing or acquiring business information.

The communication module is used for initiating a communication establishment request according to the personal unique identification code or the business information. The communication establishment module is used for receiving the communication establishment request and establishing communication.

Further, the business management module includes an information input module, a business release module and a business inquiry module.

The information input module is used for generating release information in a mode of picture insertion, text editing or scanning.

The business release module is used for constructing a business release template, embedding the release information into the release template and releasing the release information to an Internet platform server.

The business inquiry module is used for inquiring released business information in the Internet platform server. The query mode of the business inquiry module can be keyword search, and is used for searching keywords in issued information in the internet platform server, rapidly confirming business information related to the keywords through the keywords, and displaying the business information in a terminal of a user.

Further, the release template includes a plurality of editable areas. Each editable area includes a name card area;

The business release module acquires a picture through the information input module, establishes a business card background in the name card area, acquires text information and embeds the text information into the corresponding position in the name card area.

Further, the business release module is further configured to bind and store the editable area and the personal unique identification code and the communication module initiates a communication establishment request to the corresponding personal unique identification code by responding to the operation instruction to the editable area.

Further, the terminal also includes an identity recognition module which is used for acquiring the identity ID through the terminal operating system.

Further, the registration module randomly generates the personal unique identification code according to the identity ID identified by the identity identification module, and binds and stores the identity ID and the corresponding personal unique identification code in a database.

Further, the system also includes a communication setup module. The communication setup module is used for managing communication rights, and the communication rights include communications identity hiding authorities, communications time limiting authorities and communication blacklists.

Further, the identity recognition module is used for analyzing and recognizing the communication establishment request received by the communication module, and acquiring the identity ID and the communication authority of the request initiator and the communication authority of the communication target.

Further, the communications blacklist includes a plurality of storage units. The storage units are used for storing the personal unique identification codes and the plurality of storage units are configured with different communication rights and are used for limiting or opening the authorities of the stored personal unique identification codes.

Further, the communication module is further used for recording the communication process and uploading the recorded file to the cloud server after the communication is established successfully.

The invention has the beneficial effects as follows.

Compared with the prior art, the invention discloses an instant intelligent communication system for strangers, which can initiate and establish a communications through a business information issued on an Internet platform server to form service butt joint, thereby greatly facilitating abusiveness communication capability. The terminal operating system acquires the identity ID to register the personal unique identification code, so that the binding capability of the personal unique identification code and the personal identity is improved, and the safety is improved; The invention is applicable to iOS, Android, Mac and Windows, and can realize communication without obtaining the other parity's phone number, and is a global address book.

### BRIEF DESCRIPTION OF THE DRAWINGS

In order to more clearly illustrate the embodiments of the present invention or the technical solutions in the prior art, the drawings that are required to be used in the embodiments or the description of the prior art will be briefly described below, and it is obvious that the drawings in the following description are only embodiments of the present invention, and that other drawings can be obtained according to the provided drawings without creative efforts for a person skilled in the art.

FIG. 1 is a schematic diagram of an instant intelligent communication system for strangers according to the present invention.

FIG. 2 is a schematic diagram of a business management module according to the present invention.

FIG. 3 is a schematic diagram of an instant intelligent communication system for strangers according to another embodiment of the present invention.

### DETAILED DESCRIPTION OF THE EMBODIMENTS

The following description of the embodiments of the present invention will be made clearly and completely with reference to the accompanying drawings, in which it is apparent that the embodiments described are only some embodiments of the present invention, but not all embodiments. All other embodiments, which can be made by those skilled in the art based on the embodiments of the invention without making any inventive effort, are intended to be within the scope of the invention.

### Embodiment 1

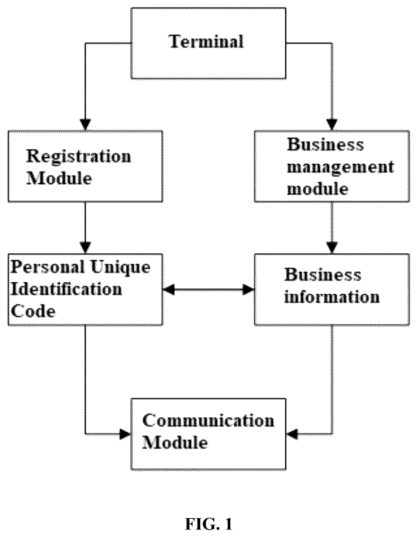

As shown in FIG. 1, an instant intelligent communication system for strangers is provided in the embodiment, which includes a registration module, a business management module, a communication module and an internet platform server.

The registration module is used for generating a personal unique identification code.

The business management module is used for publishing or acquiring business information;

The communication module is used for initiating a communication establishment request according to the personal unique identification code or the business information, receiving a communication establishment request and establishing a communication.

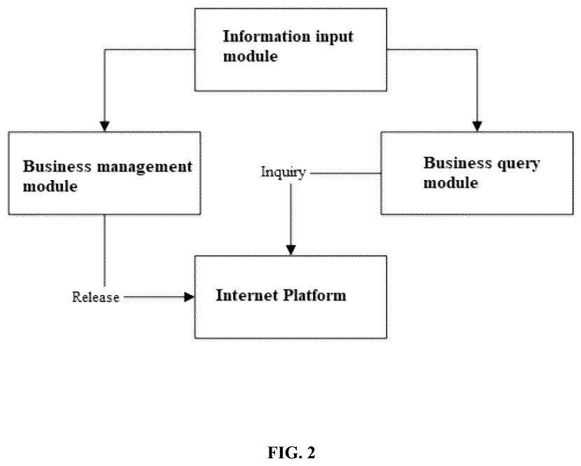

As shown in the FIG. 2, in one embodiment, the business management module includes an information input module, a business release module, and a business inquiry module.

The information input module is used for generating release information in a mode of picture insertion, text editing or scanning. When the picture is inserted, the picture can be reduced, enlarged or cut according to the size of the insertion area. The inserted picture only supports modification of the publisher of the business information and is in a released state.

The business release module is used for constructing a business release template, embedding release information into the release template and releasing the release information to the Internet platform server. The release template includes a plurality of editable areas. Each editable area includes a name card area. The business release module acquires a picture through the information input module, and establishes a business card background in a name card area and acquires the text information and embeds the text information into the corresponding position in the name card area. The business release module is also used for binding and storing the editable area and the personal unique identification code. The communication module initiates a communication establishment request to the corresponding personal unique identification code through responding to the operation instruction of the editable area.

The business inquiry module is used for querying the released business information in the Internet platform server. The query mode of the business inquiry module can be keyword search, and is used for searching keywords in the issued information in the internet platform server, rapidly confirming business information related to the keywords through the keywords, and displaying the business information in a terminal of a user.

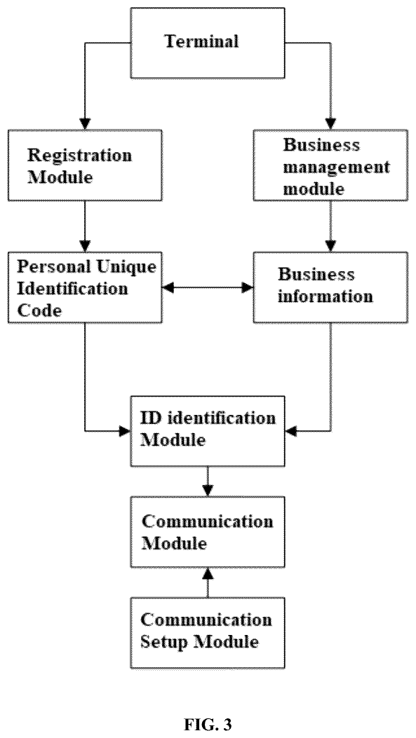

In another embodiment, as shown in FIG. 3, the system further includes an identity recognition module and a communication setup module. The identity recognition module is used for acquiring an identity ID through a terminal operating system. The registration module randomly generates a personal unique identification code according to the identity ID identified by the identity identification module, and binds and stores the identity ID and the corresponding personal unique identification code in a database.

The communication setup module is used for managing communication rights. The communication rights include communications identity hiding authorities, communications time limiting authorities and communication blacklists. The identity recognition module is used for analyzing and recognizing the communication establishment request received by the communication module and obtaining the identity ID and the communication authority of the request initiator and the communication authority of the communication target. The communication blacklists include a plurality of storage units. The storage units are used for storing personal unique identification codes. The plurality of storage units are configured with different communication rights for authority limit or opening of the stored personal unique identification codes.

In another embodiment, the system further includes a cloud server, and the communication module is further used for recording the communication process and uploading the recorded file to the cloud server after the communication is established successfully.

### Embodiment 2

The embodiment of the invention provides an instant intelligent communication method for strangers, which includes the steps as follows.

An operating system of the terminal equipment is identified, an Identity (ID) in the operating system is acquired, a registration is conducted according to the identity ID to generate a personal unique identification code and the generated personal unique identification code and the identity ID in the operating system are bind and stored.

Users log in the personal user terminal through the unique identification code to manage business and communicate. When the communications is carried out, if the communications target is determined by dialing the unique personal identification code as an initiator, a communications request is sent, and the communications can be carried out on related responsible persons of the service according to the business information acquired in the Internet platform server.

In one embodiment, business management includes information input, service release and service inquiry. The information input mode includes picture insertion, text editing or scanning. The pictures can be acquired and inserted into corresponding positions by communicating a memory of the terminal equipment, and the pictures can be acquired and inserted on line through an internet platform to edit and release business information.

When the business is released, the template which can be provided in the internet platform forms a plurality of editable areas for embedding pictures and characters and for describing own business and personal information; at least one editable area for generating a personal business card, as in the plurality of editable areas formed. Taking the generation of personal business cards as an example, a background can be formed by inserting pictures into corresponding editable areas, and meanwhile, the size of the inserted pictures can be scaled or the range of the inserted pictures can be adjusted by a picture tool. Text areas featuring on the background formed for editing personal information such as name, occupation and contact information, etc. in the form of text editing; meanwhile, the paper business card or the real certificate can be scanned, and the characters are extracted through the image, so that the editing of the business card is realized.

In addition, the information in the editable area can be bound with the personal unique identification code for storage, quick dialing can be realized by clicking the editable area in the terminal, and the Internet platform dials according to the personal unique identification code bound with the editable area and sends a communications request. Therefore, when browsing, the communications can be established for the interested service at any time.

The service inquiry is used for inquiring the released business information in the Internet platform server. The internet platform uploads business information issued by a plurality of users, and the business information is acquired in a browsing and inquiring mode, so that the related business information can be acquired. When inquiring, the internet platform can feed back the search results of the keywords and the paraphrasing to the user according to the keywords through keyword inquiry. In addition, the client can collect the related business information in the free browsing process.

In another embodiment, the method further includes identification, such as a login process, wherein when a user logs in on the terminal device, the user identity is identified by identifying the identity ID of the user in the operating system of the terminal device. When a communications is initiated, the internet platform identifies the identity and authority of a communication initiator through identity identification, and sends personal information such as the name, nickname, personal unique identification code or business card of the initiator or the like to a communication receiver together with a communication request according to the authority, so that the type of the personal information to be published can be adjusted according to the authority. Meanwhile, for a communication receiver, the internet platform acquires a personal unique identification code of the communication receiver through a communication request to confirm identity and communication rights. The personal identification code includes the personal information category and identification of other authorities such as working time and blacklist authority. By setting the working time, the time range of incoming communications can be limited. Communication requests of other users can be received only in the working time, and meanwhile, the individual users can be subjected to permanent blocking or short-time blocking through the blacklist authority. In addition, a white list can be set, and additional rights opening can be performed on the person of the white list, such as incoming communications notification outside working time or more incoming communications display elements.

In another embodiment, when a communications is conducted, according to the selection of a user, recording is conducted in the communications process, the recording file is finally uploaded to the cloud server, and the user can manage the recording file at any time without occupying the local storage space. The cloud server can delete the recording file regularly; in addition, when the voice communications is carried out, the video communications can be switched to by unlocking the camera authority.

According to the invention, the communications can be initiated and established through the business information issued on the Internet platform server, so that business docketing is formed, and the business communication capability is greatly facilitated. The terminal operating system acquires the identity ID to register the personal unique identification code, so that the binding capability of the personal unique identification code and the personal identity is improved, and the safety is improved.

In the present specification, each embodiment is described in a progressive manner, and each embodiment is mainly described in a different point from other embodiments, and identical and similar parts between the embodiments are all enough to refer to each other. For the device disclosed in the embodiment, since it corresponds to the method disclosed in the embodiment, the description is relatively simple, and the relevant points refer to the description of the method section.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An instant communication system for strangers, comprising a registration module, a business management module, a communication module and an Internet platform server;
wherein the registration module is configured to generate a personal unique identification code;
the business management module is configured to issue business information to the Internet platform server or acquire the business information from the Internet platform server;
the communication module is configured to initial a communication establishment request based on the personal unique identification code or the business information and establish a communication after receiving the communication establishment request.

2. The instant communication system for strangers of claim 1, wherein the business management module comprises an information input module, a business release module and a business inquiry module;
wherein the information input module is configured to generate release information in a mode of picture insertion, text editing or scanning;
the business release module is configured to construct a business release template, embed the release information into the release template and release the release information to the Internet platform server; and
the business inquiry module is configured to inquiring released business information in the Internet platform server.

3. The instant communication system for strangers of claim 2, wherein the release template comprises a plurality of editable areas; each editable area comprises a name card area; the business release module is configured to acquire a picture through the information input module, establish a business card background in the name card area, acquire text information and embed the text information into corresponding positions in the name card area.

4. The instant communication system for strangers of claim 3, wherein the business release module is configured to bind the editable area with the personal unique identification code for storage; and the communication module initiates a communication establishment request to the corresponding personal unique identification code by responding to the operation instruction to the editable area.

5. The instant communication system for strangers of claim 1, further comprising an identity recognition module for obtaining the identity (ID) through a terminal operating system.

6. The instant communication system for strangers of claim 5, wherein the registration module is configured to randomly generate the personal unique identification code according to the ID identified by the identification module, and store the ID and the corresponding personal unique identification code in a database.

7. The instant communication system for strangers of claim 5, further comprising a communication setup module for managing communication rights including communications identity hiding rights, communication time limiting rights, and communication blacklists.

8. The instant communication system for strangers of claim 7, wherein the identity recognition module is configured to analyze and recognize the communication establishment request received by the communication module, and obtain the identity ID and the communication rights of a request initiator and the communication rights of a communication target.

9. The instant communication system for strangers of claim 7, wherein the communication blacklists comprise a plurality of storage units for storing the personal unique identification code; and the plurality of storage units are configured with different communication rights and are used for limiting or opening the authorities of the stored personal unique identification codes.

10. The instant communication system for strangers of claim 1, further comprising a cloud server; wherein the communication module is further configured to record a communications process and upload a recording file to the cloud server after an establishment of communication.
